(19) United States
(12) Patent Application Publication
(10) Pub. No.: US 2017/0017972 A1
(43) Pub. Date: Jan. 19, 2017

(54) SERVER AND METHOD FOR PROVIDING SALES INFORMATION

(71) Applicant: OPTiM Corporation, Saga (JP)

(72) Inventor: Shunji SUGAYA, Tokyo (JP)

(21) Appl. No.: 15/157,532

(22) Filed: May 18, 2016

(30) Foreign Application Priority Data
Jul. 13, 2015 (JP) 2015-140036

(51) Int. Cl. G06Q 30/02; G06N 7/00; G06F 17/30

(52) U.S. Cl. CPC G06Q 30/0202; G06Q 30/0206; G06F 17/30312; G06N 7/005

(57) ABSTRACT

The present invention is to provide a server and a method for providing sales information that allow sellers to easily estimate the appropriate price and the sales on this price. The server for providing sales information 10, the server being communicatively connected with a seller terminal 100 that a seller uses, the information regarding the price of an article of the seller, includes an article price database that associates and stores data on an article with price data on the present price of the article; receives a price specified from the seller terminal 100 and calculates the sales forecasting probability of the article based on the specified price by referencing the article price database; and transmits the calculated sales forecasting probability to the seller terminal 100.

### CROSS REFERENCE TO RELATED APPLICATIONS

This application claims priority to Japanese Patent Application No. 2015-140036 filed on Jul. 13, 2015, the entire contents of which are incorporated by reference herein.

### TECHNICAL FIELD

The present invention relates to a server and a method for providing sales information, the server being communicatively connected with a seller terminal that a seller uses, the information regarding the price of the seller's articles.

### BACKGROUND ART

Recently, producers such as farmers have operated and managed a website to sell articles directly to consumers. In such a sales system, sellers as producers consider the commercial value and the market price of their articles to be sold to determine the price of the articles based on their estimation.

For example, sellers estimate the prices by reference to the sales price shown in websites for sales, retail stores, etc., operated by other sellers based on the names of their articles as keywords.

Moreover, the constitution in which information on the store with the lowest sales price is extracted and acquired from a plurality of stores that other sellers operate is disclosed (refer to Patent Document 1).

### CITATION LIST

### Patent Literature

Patent Document 1: JP 2014-86041A

### SUMMARY OF INVENTION

When sellers estimate the price by reference to the sales price shown in websites for sales, retail stores, etc., operated by other sellers based on the names of their articles as keywords, sellers can acquire the sales price but hardly develop the sales forecasting based on this sales price. Therefore, sellers hardly estimate the sales price of their own articles.

Moreover, according to Patent Document 1, information on the store with the lowest sales price is extracted from a plurality of stores based on specified article information, and the price of the specified article in this store is acquired and notified to a user.

However, sellers hardly judge whether or not this price is appropriate for their article, based on only the lowest price of specified article information, or hardly estimate the sales on this price.

Then, the present invention focuses on the point that the price of the articles is easily estimated based on the sales forecasting probability determined based on the prices that sellers estimate.

An objective of the present invention is to provide a server and a method for providing sales information that allow sellers to easily estimate the appropriate price and the sales on this price.

The first aspect of the present invention provides a server for providing sales information, the server being communicatively connected with a seller terminal that a seller uses, the information regarding the price of an article of the seller, including:

an article price database that associates and stores data on an article with price data on the present price of the article;

a sales forecasting probability calculation unit that receives a price specified from the seller terminal and calculates the sales forecasting probability of the article based on the specified price by referencing the article price database; and

a sales forecasting probability transmitting unit that transmits the calculated sales forecasting probability to the seller terminal.

According to the first aspect of the present invention, a server for providing sales information, the server being communicatively connected with a seller terminal that a seller uses, the information regarding the price of an article of the seller, includes an article price database that associates and stores data on an article with price data on the present price of the article; receives a price specified from the seller terminal and calculates the sales forecasting probability of the article based on the specified price by referencing the article price database; and transmits the calculated sales forecasting probability to the seller terminal.

The first aspect of the present invention falls into the category of a server for providing sales information, but the categories of a method for providing sales information has the same functions and effects.

The second aspect of the present invention provides the server according to the first aspect of the present invention, in which the sales forecasting probability calculation unit calculates the sales forecasting probability by curve fitting based on a price in a market.

According to the second aspect of the present invention, the server according to the first aspect of the present invention calculates the sales forecasting probability by curve fitting based on a price in a market.

The third aspect of the present invention provides a method for providing sales information, the information regarding the price of an article of the seller, including the steps of

associating and storing data on an article with price data on the present price of the article in an article price database;

receiving a price specified from a seller terminal and calculating the sales forecasting probability of the article based on the specified price by referencing the article price database; and

transmitting the calculated sales forecasting probability to the seller terminal.

The present invention can provide a server and a method for providing sales information that allow sellers to easily estimate the appropriate price and the sales on this price.

### BRIEF DESCRIPTION OF DRAWINGS

FIG. 1 shows an overview of the system for providing sales information 1.

FIG. 2 shows an overall configuration diagram of the system for providing sales information 1.

FIG. 3 shows a functional block diagram of the server for providing sales information 10 and the seller terminal 100.

FIG. 4 shows a flow chart of the sales information providing process performed by the server for providing sales information 10 and the seller terminal 100.

FIG. 5 shows the article data input receiving screen displayed on the seller terminal 100.

FIG. 6 shows the article data database that the server for providing sales information 10 stores.

FIG. 7 shows the sales site database that the server for providing sales information 10 stores.

FIG. 8 shows the sales data database that the server for providing sales information 10 stores.

FIG. 9 shows the article price database that the server for providing sales information 10 stores.

FIG. 10 shows the article price graph that the server for providing sales information 10 generates.

FIG. 11 shows the article data input receiving screen displayed on the seller terminal 100.

FIG. 12 shows the article price graph displayed on the seller terminal 100.

FIG. 13 shows the article price graph displayed on the seller terminal 100.

FIG. 14 shows the article price graph displayed on the seller terminal 100.

### DESCRIPTION OF EMBODIMENTS

Embodiments of the present invention will be described below with reference to the attached drawings. However, this is illustrative only, and the technological scope of the present invention is not limited thereto.

### Overview of System for Providing Sales Information 1

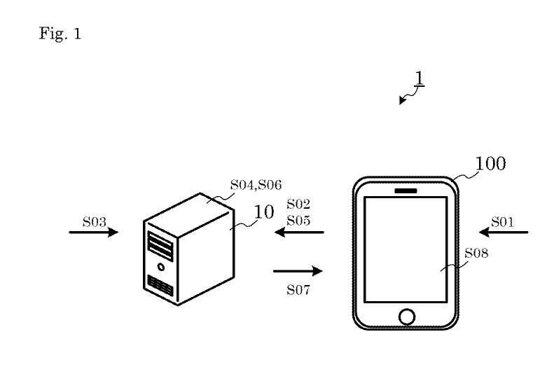

The overview of the present invention will be described below with reference to FIG. 1. The system for providing sales information 1 includes a server for providing sales information 10 and a seller terminal 100.

The server for providing sales information 10 is a server device that performs data communication with the seller terminal 100. The server for providing sales information 10 is communicatively connected with the seller terminal 100 to provide data on the price of the seller's article. The server for providing sales information 10 has an article price database that associates and stores data on an article with price data on the present price of the article. The server for providing sales information 10 also receives a price specified from the seller terminal 100 and calculates the sales forecasting probability of the article based on the specified price by referencing the article price database. The server for providing sales information 10 also transmits the calculated sales forecasting probability to the seller terminal 100.

The seller terminal 100 has a data communication function, which is a home or office electrical appliance performing data communication with the server for providing sales information 10. Examples of the seller terminal 100 include information appliances such as a mobile phone, a mobile information terminal, a personal computer, a net book terminal, a slate terminal, an electronic book terminal, and a portable music player.

The seller terminal 100 transmits the price specified by a seller to the server for providing sales information 10. The seller terminal 100 also receives and displays the sales forecasting probability transmitted from the server for providing sales information 10.

First, the seller terminal 100 receives an input of article data (step S01). The article data in this embodiment includes a product name, a desired sales amount, a production method, a production area, a size, and a possible shipping volume.

The seller terminal 100 transmits the received article data to the server for providing sales information 10 (step S02). The server for providing sales information 10 stores the received article data in the article data database.

The server for providing sales information 10 acquires the product name and the price of this article sold by a plurality of other sellers in a market as sales data based on the product name stored in the article data database (step S03). In the step S03, the server for providing sales information 10 acquires sales data through a public line network such as the Internet. In the step S03, the server for providing sales information 10 analyzes the acquired sales data and acquires the lowest price and the highest price from the prices of this article. In the step S03, the sales data that the server for providing sales information 10 acquires may contain other data on an article that include a desired sales amount, a production method, a production area, and a size. The server for providing sales information 10 may acquire other prices except the lowest price and the highest price as the prices of the article.

The server for providing sales information 10 associates and stores article data on an article with sales data containing prices in the article price database (step S04).

The seller terminal 100 receives an input of an article price and transmits data on the article price specified by a user to the server for providing sales information 10 (step S05).

The server for providing sales information 10 also receives data on the price specified from the seller terminal 100 and calculates the sales forecasting probability of the article based on the specified price by referencing the article price database (step S06). In the step S06, the server for providing sales information 10 calculates the sales forecasting probability, for example, by curve fitting using a least-squares method, etc.

The server for providing sales information 10 transmits data on the calculated sales forecasting probability to the seller terminal 100 (step S07).

The seller terminal 100 receives data on the sales forecasting probability transmitted from the server for providing sales information 10. The seller terminal 100 displays the received sales forecasting probability based on data on the received sales forecasting probability (step S08).

### Configuration of the System for Providing Sales Information 1

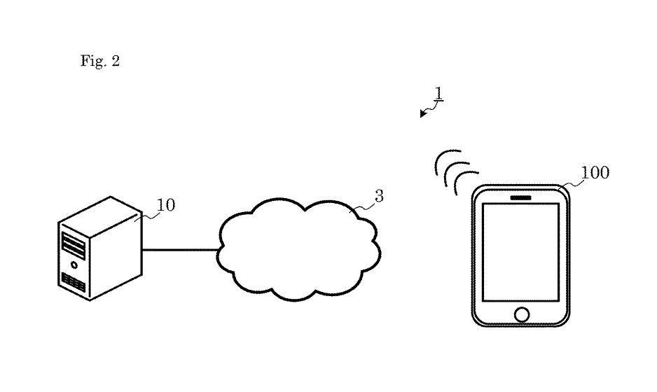

FIG. 2 shows a system configuration of the system for providing sales information 1 according to a preferable embodiment of the present invention. The system for providing sales information 1 includes a server for providing sales information 10, a seller terminal 100, and a public line network 3 (e.g. the Internet network, a third and a fourth generation networks).

The server for providing sales information 10 is a server device with the functions to be described later, which performs data communication. The server for providing sales information 10 receives various data transmitted from the seller terminal 100, acquires various data from other servers, other terminals, etc., and transmits various data to the seller terminal 100. The server for providing sales information 10 also calculates the sales forecasting probability to be described later and performs various processes including graph generation. The server for providing sales information 10 also stores an article data database, a sales site database, a sales data database, and an article price database that are to be described later.

The seller terminal 100 has a data communication function, which is a home or office electrical appliance performing data communication with the server for providing sales information 10. Examples of the seller terminal 100 include information appliances such as a mobile phone, a mobile information terminal, a personal computer, a net book terminal, a slate terminal, an electronic book terminal, and a portable music player.

The seller terminal 100 transmits various data to the server for providing sales information 10. The seller terminal 100 also receives various data from the server for providing sales information 10. The seller terminal 100 also displays various data received from the server for providing sales information 10.

### Functions

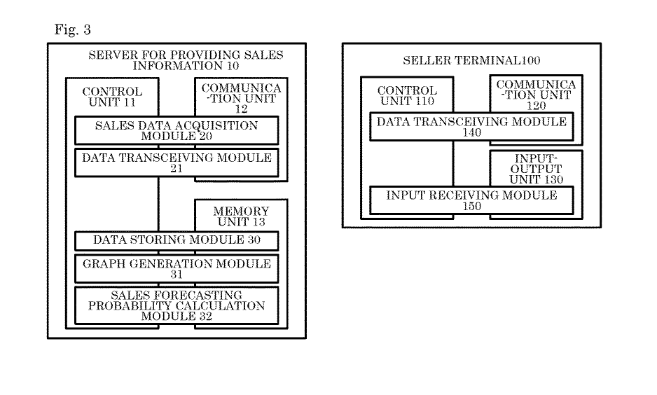

The structure of each device will be described below based on FIG. 3.

The server for providing sales information 10 includes a control unit 11 provided with a central processing unit (hereinafter referred to as “CPU”), a random access memory (hereinafter referred to as “RAM”), and a read only memory (hereinafter referred to as “ROM”); and a communication unit 12 such as a device with capability of communicating with other devices, for example, a Wireless Fidelity or Wi-Fi® enabled device complying with IEEE 802.11. The server for providing sales information 10 also includes a memory unit 13 such as a hard disk, a semiconductor memory, a record medium, or a memory card to store data. The memory unit 13 stores an article data database, a sales site database, a sales data database, and an article price database that are to be described later.

In the server for providing sales information 10, the control unit 11 reads a predetermined program to run a sales data acquisition module 20 and a data transceiving module 21 in cooperation with the communication unit 12. Furthermore, in the server for providing sales information 10, the control unit 11 reads a predetermined program to run a data storing module 30, a graph generation module 31, and a sales forecasting probability calculation module 32 in cooperation with the memory unit 13.

The seller terminal 100 includes a control unit 110 including a CPU, a RAM, and a ROM; and a communication unit 120 such as a device with capability of communicating with other devices, for example, a Wireless Fidelity or Wi-Fi® enabled device complying with IEEE 802.11 in the same way as the server for providing sales information 10. The seller terminal 100 also includes an input-output unit 130 such as a display unit outputting and displaying data and images that have been processed by the control unit; and also including an input unit such as a touch panel, a keyboard, or a mouse that receive an input from a user.

In the seller terminal 100, the control unit 110 reads a predetermined program to run a data transceiving module 140 in cooperation with the communication unit 120. Furthermore, in the seller terminal 100, the control unit 110 reads a predetermined program to run an input receiving module 150 in cooperation with the input-output unit 130.

### Sales Information Providing Process

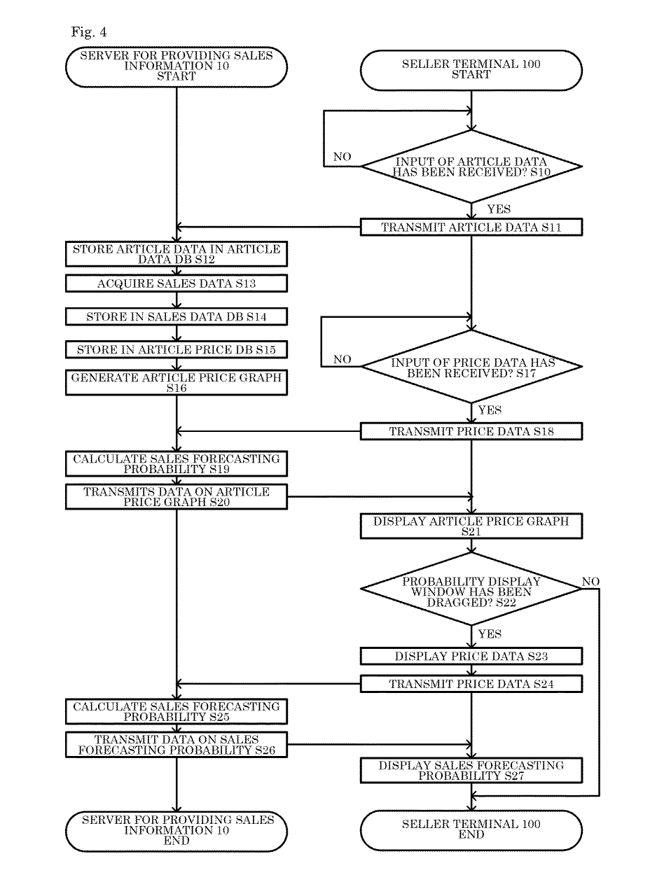

FIG. 4 shows a flow chart of the sales information providing process performed by the server for providing sales information 10 and the seller terminal 100. The tasks executed by the modules of each of the above-mentioned devices will be explained below together with the process.

First, the input receiving module 150 of the seller terminal 100 judges whether or not the input receiving module 150 has received an input of article data (step S10). In the step S10, the article data that the input receiving module 150 receives includes a product name, a desired sales amount, a production method, a production area, a size, and a possible shipping volume. The input receiving module 150 only has to judge whether or not the input receiving module 150 has received an input of at least a product name. Other article data may not be input.

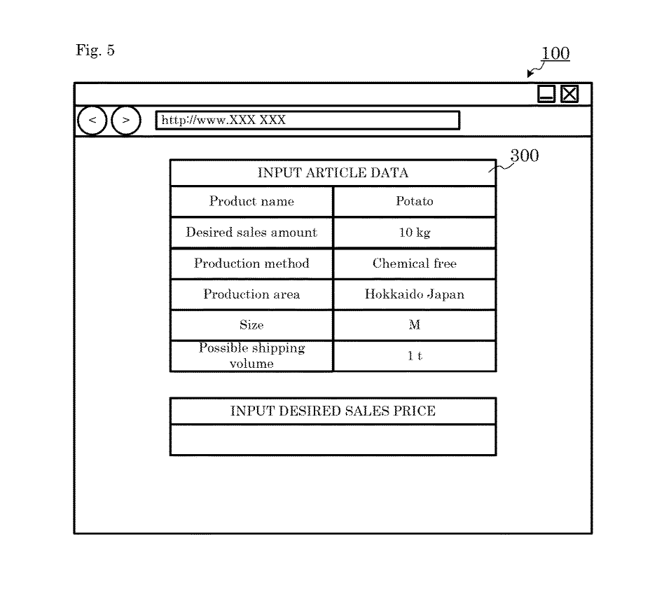

In the step S10, the input receiving module 150 of the seller terminal 100 starts a predetermined application to display the article data input receiving screen shown in FIG. 5. The input receiving module 150 receives an input for the items in the article data input window 300. In FIG. 5, the article data input window 300 displays the items “Product name,” “Desired sales amount,” “Production method,” “Production area,” “Size,” and “possible shipping volume” with the respective input fields.

In the step S10, if judging that the input receiving module 150 has not received an input of article data (NO), the input receiving module 150 repeats the process until receiving the input.

On the other hand, if judging that the input receiving module 150 of the seller terminal 100 has received an input of article data (YES) in the step S10, the data transceiving module 140 of the seller terminal 100 transmits the received article data to the server for providing sales information 10 (step S11).

In this embodiment, the input receiving module 150 receives an input of “Potato” as “Product name,” “10 kg” as “Desired sales amount,” “Chemical free” as “Production method,” “Hokkaido Japan” as “Production area,” “M” as “Size,” and “1 t” as “Possible shipping volume.” The input receiving module 150 may judge only whether or not the input receiving module 150 has received an input for the item “Product name” to judge whether or not the input receiving module 150 has received an input of article data. Alternatively, the input receiving module 150 may judge whether or not the input receiving module 150 has received an input for any of the above-mentioned items to judge whether or not the input receiving module 150 has received an input of article data. The article data input window 300 that the input receiving module 150 displays may display other items or may not display all of the items other than “Product name.”

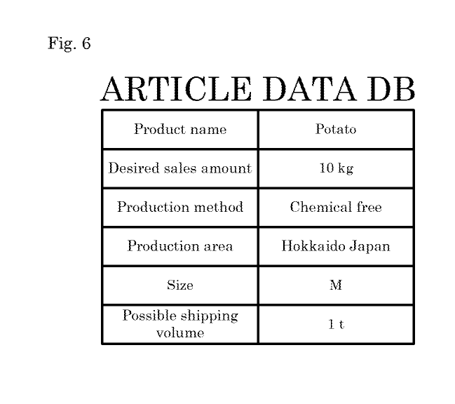

The data transceiving module 21 of the server for providing sales information 10 receives the article data transmitted from the seller terminal 100. The data storing module 30 of the server for providing sales information 10 stores the received article data in the article data database shown in FIG. 6 (step S12).

### Article Data Database

FIG. 6 shows the article data database that the data storing module 30 of the server for providing sales information 10 stores. The data storing module 30 associates and stores the items with the respective values included in the article data input and received from the seller terminal 100. Specifically, in FIG. 6, the data storing module 30 associates and stores “Potato” with “Product name,” “10 kg” with “Desired sales amount,” “Chemical free” with “Production method,” “Hokkaido Japan” with “Production area,” “M” with “Size,” and “1 t” with “Possible shipping volume.” If the article data contain other items, the data storing module 30 may associate and store these items with the respective values included in the article data input and received from the seller terminal 100. The data storing module 30 may store any data included in the article data. In this case, the data storing module 30 only has to store at least “Product name” as article data.

Then, the sales data acquisition module 20 of the server for providing sales information 10 acquires a plurality of sales data on this article based on the article data database stored in the step S12 (step S13). The sales data that the sales data acquisition module 20 acquires is price data on the present prices of the input article that the seller terminal 100 has received. In the step S13, the sales data acquisition module 20 of the server for providing sales information 10 acquires sales data from the websites such as shopping sites where other sellers sell the article.

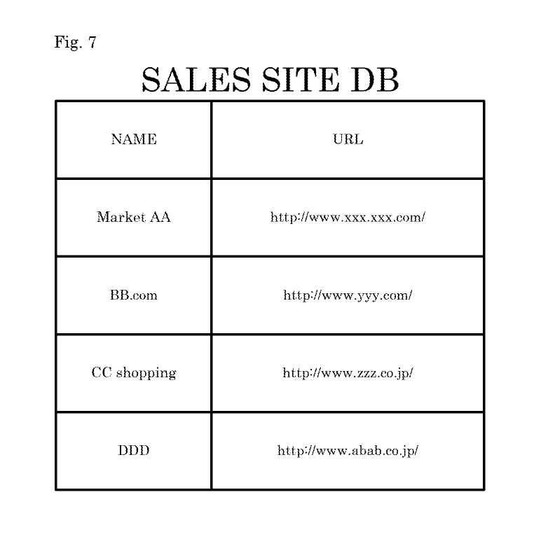

The data storing module 30 of the server for providing sales information 10 previously associates and stores the URL of the websites from which the sales data acquisition module 20 acquires sales data with the name of the websites in the sales site database shown in FIG. 7. The sales data acquisition module 20 acquires the sales data on this article by accessing the URLs and extracting the product name from the received article data. The sales data acquisition module 20 may retrieve the product name extracted from the article data by a search site, etc. through a public line network such as the Internet and then extract and acquire sales data from the search result.

### Sales Site Database

FIG. 7 shows the sales site database that the data storing module 30 of the server for providing sales information 10 stores. In FIG. 7, the data storing module 30 associates and stores the name with the URL of a website. The data storing module 30 associates and stores the URL “http://www.xxx.xxx.com/” with the name “Market AA” of a website. The data storing module 30 also associates and stores the URL “http://www.yyy.com/” with the name “BB.com” of a website. The data storing module 30 also associates and stores the URL “http://www.zzz.co.jp/” with the name “CC shopping” of a website. The data storing module 30 also associates and stores the URL “http://www.abab.co.jp/” with the name “DDD” of a website. The data storing module 30 may store the URL a website such as a search site or may store the name and the URL of other websites.

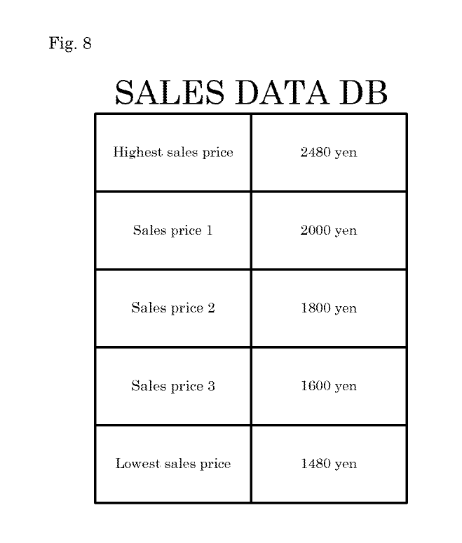

The data storing module 30 of the server for providing sales information 10 stores the sales data acquired in the step S13 in the sales data database shown in FIG. 8 (step S14).

FIG. 8 shows the sales data database that the data storing module 30 of the server for providing sales information 10 stores. The data storing module 30 stores the present sales data on the article. The data storing module 30 also stores a plurality of sales data. In FIG. 8, the data storing module 30 stores the highest price among the plurality of sales data that the sales data acquisition module 20 has acquired, as the highest sales price. The data storing module 30 also stores the lowest price among the plurality of sales data that the sales data acquisition module 20 has acquired, as the lowest sales price. The data storing module 30 stores the prices except the highest and the lowest prices among the plurality of sales data that the sales data acquisition module 20 has acquired, as the sales prices. The data storing module 30 sorts and stores the prices in descending order in the sales data database. The data storing module 30 may store the price data in the order in which the sales data acquisition module 20 acquired, in ascending order, or in other orders or may store only the highest sales price and the lowest sales price.

In FIG. 8, the data storing module 30 of the server for providing sales information 10 stores “2480 yen” as “Highest sales price,” “2000 yen” as “Sales price 1,” “1800 yen” as “Sales price 2,” “1600 yen” as “Sales price 3,” and “1480 yen” as “Lowest sales price.”

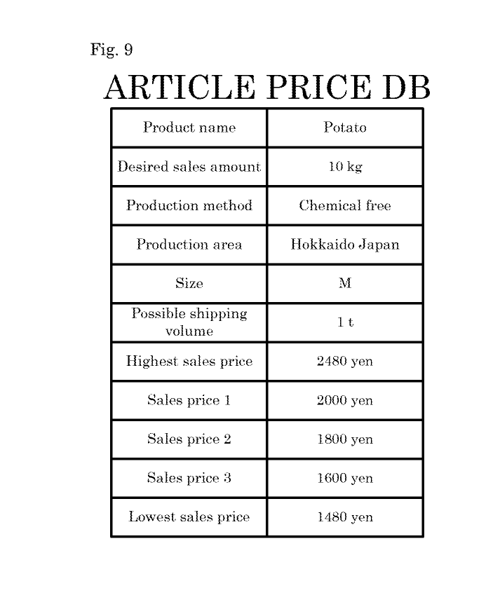

The data storing module 30 of the server for providing sales information 10 associates the above-mentioned article data database with the sales data database to store in the article price database shown in FIG. 9 (step S15).

### Article Price Database

FIG. 9 shows the article price database that the data storing module 30 of the server for providing sales information 10 stores. The data storing module 30 associates and stores the above-mentioned article database with the sales data database. In the article price database that the data storing module 30 stores, the highest sales price, the lowest sales price, and the sales prices are price data at present, i.e., at the time when the sales data acquisition module 20 acquired. The price data is updated whenever changed. The data storing module 30 may add a date and time, etc., to newly acquired price data in the article price database if the price data including the highest sales price, the lowest sales price, and the sales prices are changed. In other words, the data storing module 30 may store both the past price data and the present price data. This keeps the price data up to date with maintaining the past price data.

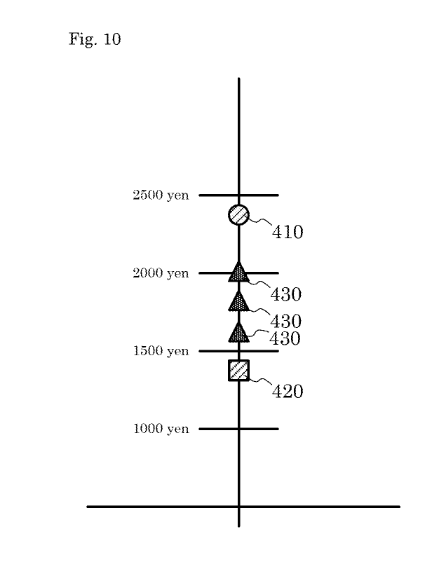

The graph generation module 31 of the server for providing sales information 10 references the article price database stored in the step S15 and generates the article price graph shown in FIG. 10 based on the price data on the article (step S16).

### Article Price Graph

FIG. 10 shows the article price graph that the graph generation module 31 of the server for providing sales information 10 generates. In FIG. 10, the ordinate axis indicates prices. The graph generation module 31 marks the ordinate axis in increments of 500 yen to generate scale marks and also generates the highest sales price, the lowest sales price, and the sales prices in respective predetermined display forms. In FIG. 10, the graph generation module 31 generates a highest sales price icon 410 as the display form of the highest sales price at the corresponding position. The graph generation module 31 also generates a lowest sales price icon 420 as the display form of the lowest sales price at the corresponding position. The graph generation module 31 also generates sales price icons 430 as the display form of the sales prices 1 to 3 at the respective corresponding positions 1 to 3. The graph generation module 31 may generate the highest sales price icon 410, the lowest sales price icon 420, and the sales price icons 430 in other display forms. The display forms can be appropriately changed. The scale marks, the ordinate axis, etc. can also be appropriately changed.

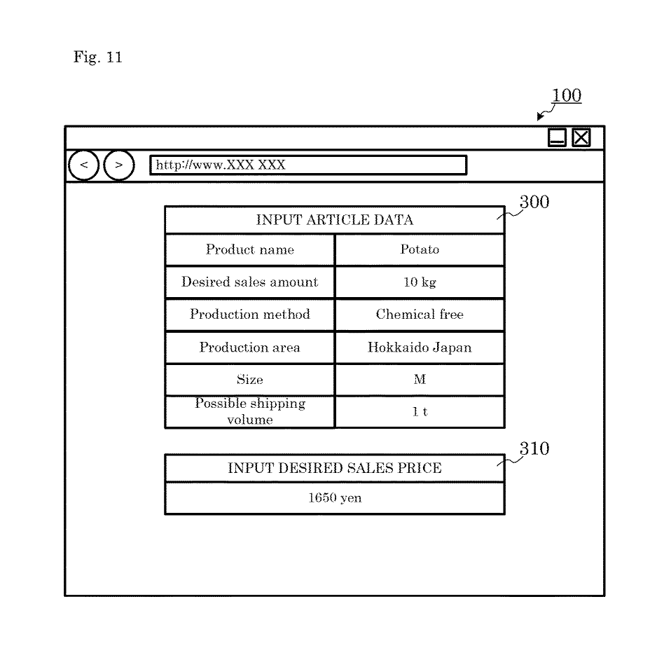

Then, the input receiving module 150 of the seller terminal 100 judges whether or not the input receiving module 150 has received an input of price data on the article (step S17). In the step S17, the input receiving module 150 starts a predetermined application to display the article data input receiving screen shown in FIG. 11. In FIG. 11, the input receiving module 150 displays a desired sales price input window 310 in the article data input screen information. The input receiving module 150 judges whether or not price data has been input in this desired sales price input window 310.

In the step S17, if judging that price data has not been input (NO), the input receiving module 150 judges that the input receiving module 150 has not received an input of price data on the article, and then repeats the process until receiving the input.

On the other hand in the step S17, if judging that price data has been input (YES), the input receiving module 150 judges that the input receiving module 150 has received an input of price data on the article. The data transceiving module 140 of the seller terminal 100 then transmits the received price data on the article to the server for providing sales information 10 (step S18). This embodiment is explained as the example in which the input receiving module 150 receives an input of “1650 yen” as the price data.

The data transceiving module 21 of the server for providing sales information 10 receives the price data transmitted from the seller terminal 100. The sales forecasting probability calculation module 32 of the server for providing sales information 10 calculates the sales forecasting probability of this article based on the price data specified from the seller terminal 100 by referencing the above-mentioned article price database (step S19).

In the step S19, the sales forecasting probability calculation module 32 of the server for providing sales information 10 calculates the sales forecasting probability by curve fitting using a least squares method, etc., based on the highest sales price and the lowest sales price stored in the article price database. The case where the sales forecasting calculation module 32 calculates the sales forecasting probability based on only the highest sales price and the lowest sales price will be explained below. In the description below, the sales forecasting probabilities based on the highest sales price and the lowest sales price that the sales forecasting probability calculation module 32 uses are assumed to be 10% and 100%, respectively. The highest sales price and the lowest sales price are assumed to be “2480 yen” and “1480 yen,” respectively, which are stored in the above-mentioned article price database.

The sales forecasting probability calculation module 32 of the server for providing sales information 10 generates a graph in which the X axis and the Y axis indicate the price and the probability, respectively. If the highest sales price and the lowest sales price are approximated by the linear function Y=AX+B, the highest sales price and the lowest sales price are plotted at (X,Y)=(2480,10) and (X,Y)=(1480,100), respectively. This leads to the calculation of the slope A and the y-intercept B. The sales forecasting probability calculation module 32 calculates the slope A=−0.09 and the y-intercept B=233.2 from the above-mentioned equation. Then, the values of the calculated slope A and the y-intercept B are assigned to the above-mentioned equation to calculate Y=−0.09X+233.2. The price data “1650 yen” transmitted from the seller terminal 100 is assigned to X of this equation to determine Y=84.7% in the step S18. The value of this Y is a sales forecasting probability.

The sales forecasting probability calculation module 32 of the server for providing sales information 10 may calculate the sales forecasting probability by other methods or based on the highest sales price, the lowest sales price, and the sales prices.

In the step S19, the graph generation module 31 of the server for providing sales information 10 adds the sales forecasting probability that the sales forecasting probability calculation module 32 has calculated to the article price graph generated in the step S16 and transmits the data on this article price graph to the seller terminal 100 (step S20). In the step S20, the graph generation module 31 plots the sales forecasting probability and the price data on which this sales forecasting probability is based, to the positions corresponding to these price data.

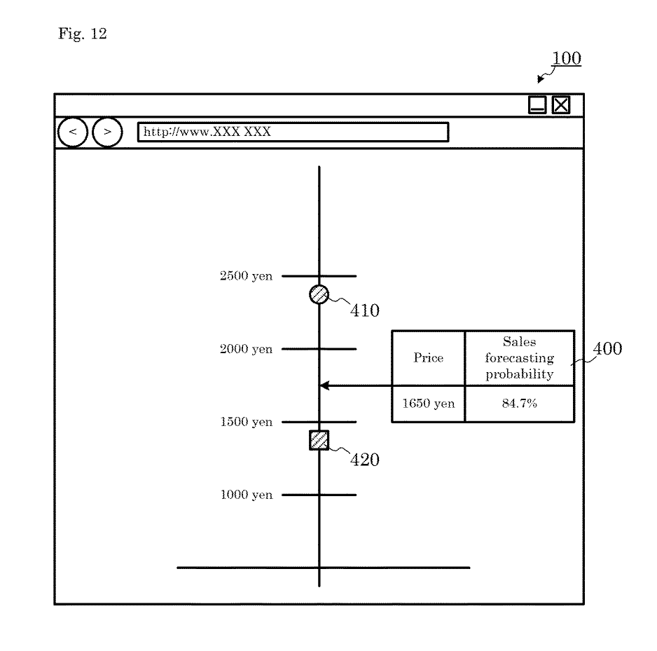

The data transceiving module 140 of the seller terminal 100 receives the data on the article price graph transmitted from the server for providing sales information 10. The input receiving module 150 of the seller terminal 100 starts a predetermined application to display the article price graph display screen shown in FIG. 12 based on the received data on the article price graph (step S21).

In FIG. 12, the ordinate axis indicates the price. The input receiving module 150 displays a scale marked in increments of 500 yen and also displays the highest sales price, the lowest sales price, the sales prices, the input price data received in the step S17, and the sales forecasting probability based on these price data at the respective corresponding positions in the respective predetermined display forms, based on the data on the article price graph. In FIG. 12, the input receiving module 150 displays a highest sales price icon 410 as the display form of the highest sales price at the corresponding position. The input receiving module 150 also displays a lowest sales price icon 420 as the display form of the lowest sales price at the corresponding position. The input receiving module 150 displays a probability display window 400 to show the price data and the sales forecasting probability based on these price data at the positions corresponding to these price data. This probability display window 400 can receive an input from the user, which can be dragged along the ordinate axis.

The input receiving module 150 displays the probability display window 400, the highest sales price icon 410, the lowest sales price icon 420, and the sales price icons 430 in other display forms. The display forms can be appropriately changed. The probability display window 400 may be moved by voice instruction from the user that the input receiving module 150 recognizes. The input receiving module 150 may also display sales price icons 430 as the display form of the sales prices 1 to 3 at the respective corresponding positions 1 to 3.

The input receiving module 150 of the seller terminal 100 judges whether or not the user has dragged the probability display window 400 (step S22). In the step S22, if judging that the user has not dragged the probability display window 400 (NO), the input receiving module 150 ends this process.

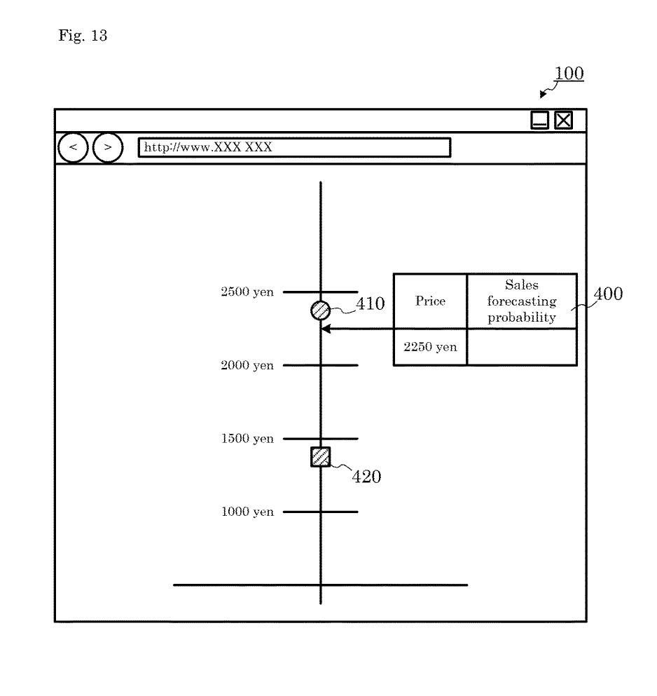

On the other hand, if judging that the user has dragged the probability display window 400 (YES) in the step S22, the input receiving module 150 displays the price data at the point to which this probability display window 400 has been dragged, in the probability display window 400 in the article price graph shown in FIG. 13 (step S23). In the step S23, the input receiving module 150 may display the price data at the point whenever the probability display window 400 is dragged or at the point when the probability display window 400 stops, in the probability display window 400. This embodiment is explained as the example in which the point to which the probability display window 400 has been dragged is where the price data is “2250 yen.”

The data transceiving module 140 of the seller terminal 100 transmits the price data that the input receiving module 150 displays in the probability display window 400 in the step S23, to the server for providing sales information 10 (step S24).

The data transceiving module 21 of the server for providing sales information 10 receives the price data transmitted from the seller terminal 100. The sales forecasting probability calculation module 32 of the server for providing sales information 10 calculates the sales forecasting probability based on the received price data (step S25). In the step S25, the sales forecasting probability calculation module 32 calculates the sales forecasting probability by the same process as the above-mentioned step S19. The sales forecasting probability in this embodiment is “30.7%.”

The data transceiving module 21 of the server for providing sales information 10 transmits data on the sales forecasting probability calculated in the step S25 to the seller terminal 100 (step S26).

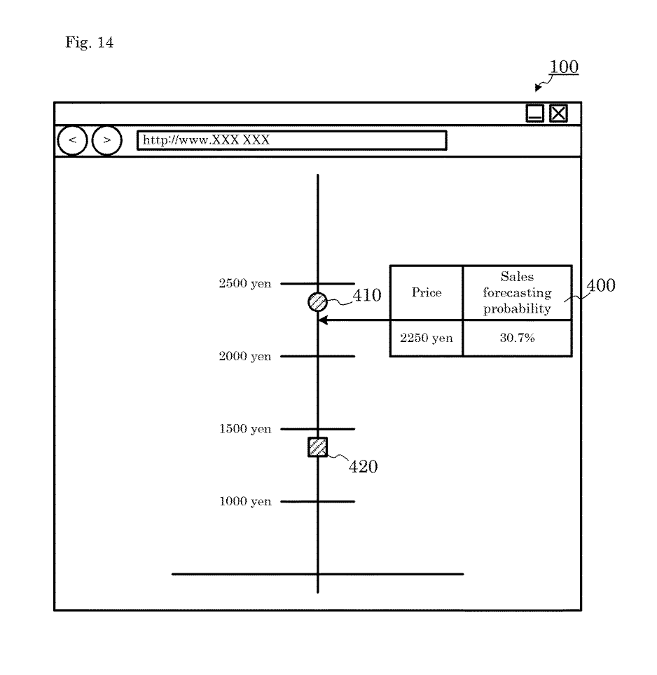

The data transceiving module 140 of the seller terminal 100 receives the data on the sales forecasting probability transmitted from the server for providing sales information 10. The input receiving module 150 of the seller terminal 100 displays the sales forecasting probability at this point in the probability display window 400 of the article price graph shown in FIG. 14 based on the received data on the sales forecasting probability (step S27).

To achieve the means and the functions that are described above, a computer (including a CPU, an information processor, and various terminals) reads and executes a predetermined program. For example, the program is provided in the form recorded in a computer-readable medium such as a flexible disk, CD (e.g., CD-ROM), or DVD (e.g., DVD-ROM, DVD-RAM). In this case, a computer reads a program from the record medium, forwards and stores the program to and in an internal or an external storage, and executes it. The program may be previously recorded in, for example, a storage (record medium) such as a magnetic disk, an optical disk, or a magnetic optical disk and provided from the storage to a computer through a communication line.

The embodiments of the present invention are described above. However, the present invention is not limited to the above-mentioned embodiments. The effect described in the embodiments of the present invention is only the most preferable effect produced from the present invention. The effects of the present invention are not limited to that described in the embodiments of the present invention.

### REFERENCE SIGNS LIST

1 System for providing sales information
10 Server for providing sales information
100 Seller terminal

What is claimed is:

1. A server for providing sales information, the server being communicatively connected with a seller terminal that a seller uses, the information regarding the price of an article of the seller, comprising:
an article price database that associates and stores data on an article with price data on the present price of the article;
a sales forecasting probability calculation unit that receives a price specified from the seller terminal and calculates the sales forecasting probability of the article based on the specified price by referencing the article price database; and
a sales forecasting probability transmitting unit that transmits the calculated sales forecasting probability to the seller terminal.

2. The server according to claim 1, wherein the sales forecasting probability calculation unit calculates the sales forecasting probability by curve fitting based on a price in a market.

3. A method for providing sales information, the information regarding the price of an article of the seller, including the steps of:
associating and storing data on an article with price data on the present price of the article in an article price database;
receiving a price specified from a seller terminal and calculating the sales forecasting probability of the article based on the specified price by referencing the article price database; and
transmitting the calculated sales forecasting probability to the seller terminal.
